(19) United States
(12) Patent Application Publication
(10) Pub. No.: US 2010/0228767 A1
(43) Pub. Date: Sep. 9, 2010

(54) DETERMINING RELATIONSHIPS BETWEEN INDIVIDUALS IN A DATABASE

(76) Inventors: Scott W. Slinker, San Jose, CA (US); Anthony A. Shah-Nazaroff, Santa Clara, CA (US); James T. Brady, San Jose, CA (US)

Correspondence Address: SCHWEGMAN, LUNDBERG & WOESSNER, P.A., P.O. BOX 2938, MINNEAPOLIS, MN, 55402, US

(21) Appl. No.: 12/701,536

(22) Filed: Feb. 6, 2010

Related U.S. Application Data
(60) Provisional application No. 61/150,615, filed on Feb. 6, 2009.
(60) Provisional application No. 61/295,158, filed on Jan. 14, 2010.

(51) Int. Cl. G06F 17/30

(52) U.S. Cl. 707/769; 707/E17.014

(57) ABSTRACT

A system comprising a database containing information concerning uniquely identified individuals. The database further contains a list of attributes describing the individuals. A server compares the list of attributes of a first individual to another list of attributes for a second individual. The server further provides one or more metrics indicating a degree of match of the first individual to the second individual.

### CROSS-REFERENCE TO RELATED PATENT DOCUMENTS

The present application claims the benefit of priority under 35 U.S.C. Section 119(e) to U.S. Provisional Patent Application Ser. No. 61/150,615, filed on Feb. 6, 2009, and to U.S. Provisional Patent Application Ser. No. 61/295,158, filed on Jan. 14, 2010, which applications are incorporated herein by reference in their entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2010, Jake Knows, Inc., All Rights Reserved.

### TECHNICAL FIELD

Example embodiments relate to discovering, and determining the strength of relationships between people based on a database that links one or more attributes associated with each person, such that trustworthiness, skills, competence, or interests of a person can be determined more reliably.

### BACKGROUND OF THE INVENTION

In a world where most people have several identities, databases containing descriptions of the identities are susceptible to having unknown duplicates of identities, fraudulent identities claiming to be a valid identity. These problems result in misidentification of real people and failure to detect fraudulent identities.

### BRIEF DESCRIPTION OF THE DRAWINGS

FIG. 1 is a representation of a system configuration, according to an example embodiment.

FIG. 2 is a drawing of the Cell phone client architecture, according to an example embodiment.

FIG. 3 is a drawing of an Internet appliance architecture, according to an example embodiment.

FIG. 4 is a drawing of the server architecture, according to an example embodiment.

FIG. 5 is a representation of the person table entry, according to an example embodiment.

FIG. 6 is a representation of a contact list entry, according to an example embodiment.

FIG. 7 is a table depicting a communications history, according to an example embodiment.

FIG. 8 is a representation of the communications log, according to an example embodiment.

FIG. 9 is a representation of an attribute descriptor, according to an example embodiment.

FIG. 10 is a table depicting a node control block, according to an example embodiment.

FIG. 11 is a diagram of a representative attribute graph, according to an example embodiment.

FIG. 12 is a flow diagram of the combined descriptor list build process, according to an example embodiment.

FIG. 13 is a drawing of an evaluation, according to an example embodiment.

FIG. 14 is a table depicting an analysis table, according to an example embodiment.

FIG. 15 is a table representing an attribute list, according to an example embodiment.

FIG. 16 describes the combined descriptor list record, according to an example embodiment.

FIG. 17 describes the weigh factors table for the various attributes and person data fields, according to an example embodiment.

FIG. 18 is a drawing of a construct AT, according to an example embodiment.

FIG. 19 is a drawing of an evaluate person/persona, according to an example embodiments.

FIG. 20 is a table depicting a person statistics DB, according to an example embodiment.

FIG. 21 is a table describing cut factors, according to an example embodiment.

FIG. 22 describes the persona table entry, according to an example embodiment.

FIG. 23 is a flow diagram of Add person, according to an example embodiment.

FIG. 24 is a table depicting generated statistics, according to an example embodiment.

FIG. 25 is a block diagram of machine in the example form of a computer system within which a set instructions, for causing the machine to perform any one or more of the methodologies discussed herein, may be executed.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

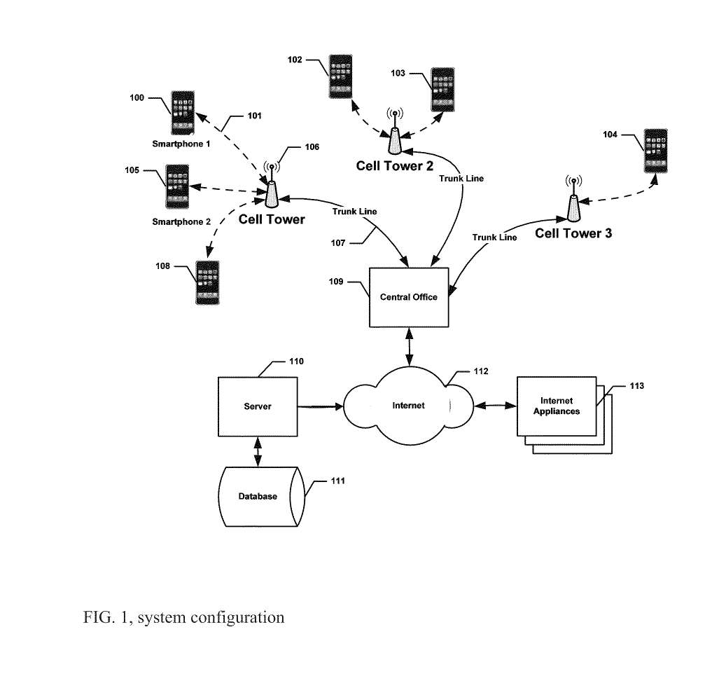

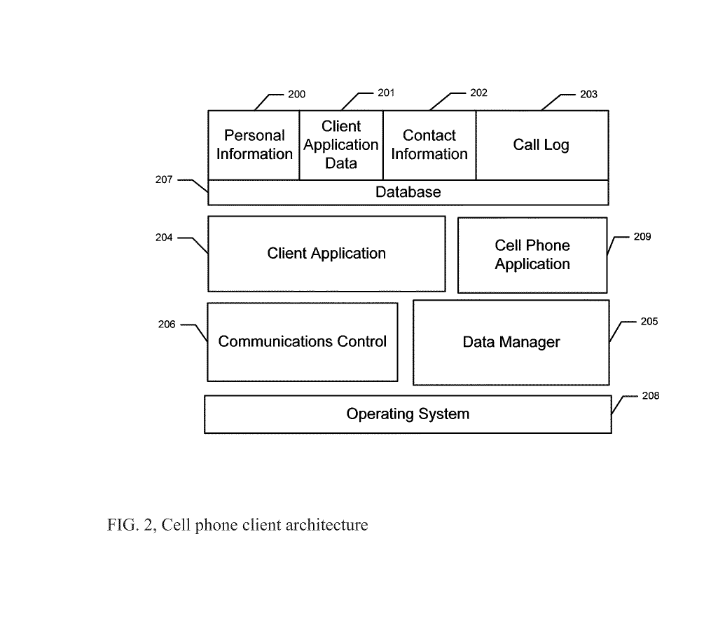

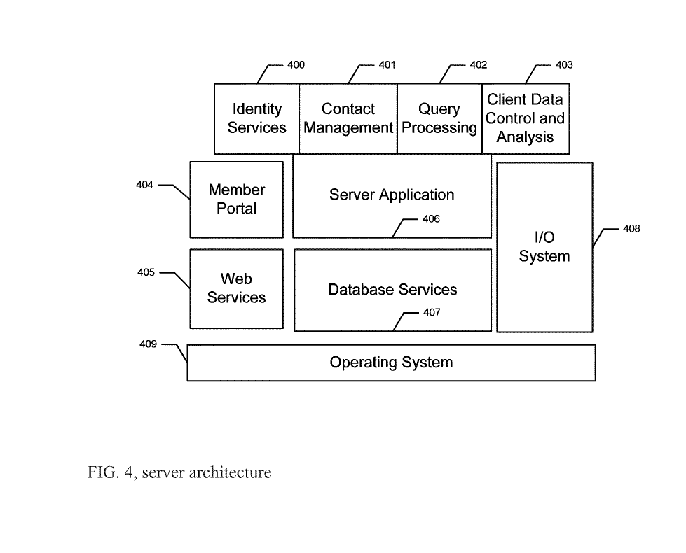

FIG. 1 is a block diagram illustrating an environment in which various example embodiments may be deployed. Elements 100, 102, 103, 104, 105, through 108 are smart phones and feature phones (phones) which are connected through the various wireless networks that are currently in place to support communications with the devices. The phone 100 connects via the most accessible cell tower 106, via a trunk line 107 to a central office 109 using standard technology. Additionally internet appliances 113 are connected through the internet 112. Each phone has a software structure similar to the cell phone client architecture described below with reference to FIG. 2. Each of the mobile devices and internet appliances hosts a client application 204. The client application 204 collects information about the individual that uses the phone, and transmits the information through links (e.g., cell phone radio transmission link 101, one or more trunk lines 107, and the internet 112) to an application server, in the example form of an association server 110. The association server 110 has the software architecture described below with reference to FIG. 4. Within the association server 110, a server application 406 receives the information and adds it to one of the database components. After the information is added to the database 111, it is processed in the server application 406 by executing the processes describe herein.

FIG. 2 is a block diagram depicting a cell phone client architecture, according to an example embodiment. The cell phone client architecture is composed of an operating system 208, which is provided by manufacturer of the smart phones 100. The operating system 208 provides the base hardware control mechanism. The services communications control 206, database 207, and data manager 205 are built on the operating system's services. A communications control 206 is an interface from the client to the communications network used. In the case of the cell phone based systems, the network may be the common carriers network, represented by trunk line 107 and central office 109, linked to the internet. For the internet appliances 113, the network is the internet 112. The communications control 206 is interfaced with the client application 204 and acts as the port for the client application's 204 communications with the association server 110. The data manager 205 controls the physical storage in the client and controls access, security, space management for the client application 204, cell phone application 209, and database 207. The client application 204 provides the user interface to the various services provided by the associative server. The cell phone application 209 is provided by the cell phone vendor and provides the cell phone services to the user. A database 207 manages the information in the various databases of personal information 200, client application data 201, contact information 202 and the call log 203, and provides the query and update services for these data. Personal information 200 contains information about the user. The personal information may be extended by the client application 204 to include information required to support the association server 110 applications. Client application data 201 contains the new data structures required to support the client application 204. Contact information 202 supports the cell phone/web application contact list features. It is augmented by the client application 204 to support the requirements of the association server 110 applications. Call log 203 is provided by the cell phone/web application and contains information about the user's contacts. It is accessed by the client application 204 to support the functions taught herein.

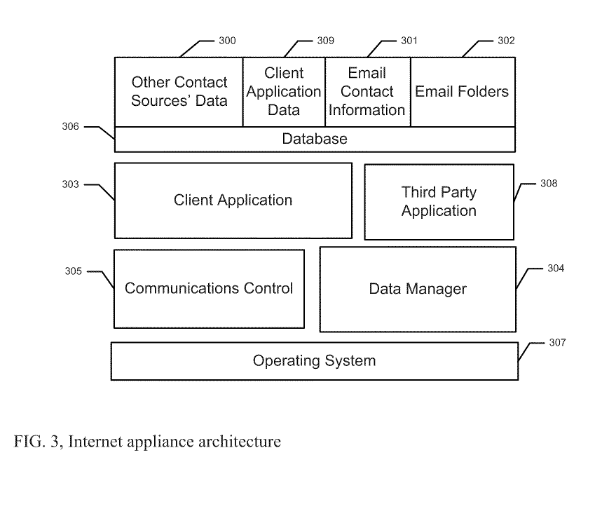

FIG. 3 is a block diagram depicting in internet appliance client architecture, according to an example embodiment. The internet appliance client architecture is composed of an operating system 307, which is provided by manufacturer of the client system. The operating system provides the base hardware control mechanism. A services communications control 305, database 306, and data manager 304 are built on the operating system's services. The communications control 305 is an interface from the client to the communications network used. In the case of the cell phone based systems. The network may be the common carriers network, represented by trunk line 107 and central office 109, linked to the internet. For the internet appliances 113, the network is the internet 112. The communications control 305 is interfaced with client application 303 and acts as the port for the client application's 303 communications with the association server 110 The data manager 304 controls the physical storage in the client and controls access, security, space management for the client application 303, third party applications 308 and database 306. The client application 303 provides the user interface to the various services provided by the association server 110. Third party applications 308 are provided by a number of sources and share the internet appliance 113 with the client application 303. The database 306 manages the information in the various databases of other contact sources' data 300, client application data 309, email contact information 301 and the email folders 302, and provides the query and update services for these data. Other contact sources' data 300 contains information about the user contact such as photograph, likes and dislikes, activities participated in, etc. Client application data 309 contains the new data structures required to support the client application 303. Email contact information 301 is used by email programs for the user's contacts. It is augmented by the client application 303 to support the requirements of the applications hosted on the association server 110. Email folders 302 contain the email that has been received and sent by the user. It is the analog of the call log 203 shown in the FIG. 2 cell phone client architecture. It is accessed by the client application 303 to support the requirements of the function taught herein.

FIG. 4 is a block diagram depicting a server architecture for the association server, according to an example embodiment. The association server 110 software architecture includes a conventional operating system 409 like IBM'S Z/OS, LINUX, UNIX, and MICROSOFT WINDOWS 7 among others. On top of that base is an I/O system 408, which provides for the software to manage all I/O devices including disk storage and communications hardware. It is used by all the components of the system for these services. Database services 407 provide a repository for data structures of the server application 406. These data structures may be stored in a variety of forms including flat files, relational, hierarchical, and object databases. Web services 405 provide the protocols and controls necessary to attach to the Internet 112. Web services 405 are used by server application 406 to communicate with the various client machines. A member portal 404 receives messages from the clients from the Web service 405 and passes them to the server application 406, which executes the various processes described herein. The server application 406 is further subdivided into the functions including, in an example embodiment: identity services 400 (e.g., registration, login, and verification), contact management 401 (e.g., discovery, validation, and association analysis), query processing 402, and client data control and analysis 403. The structure and arrangement of the components of server architecture is one of a number of implementations that one skilled in the state-of-the-art could design.

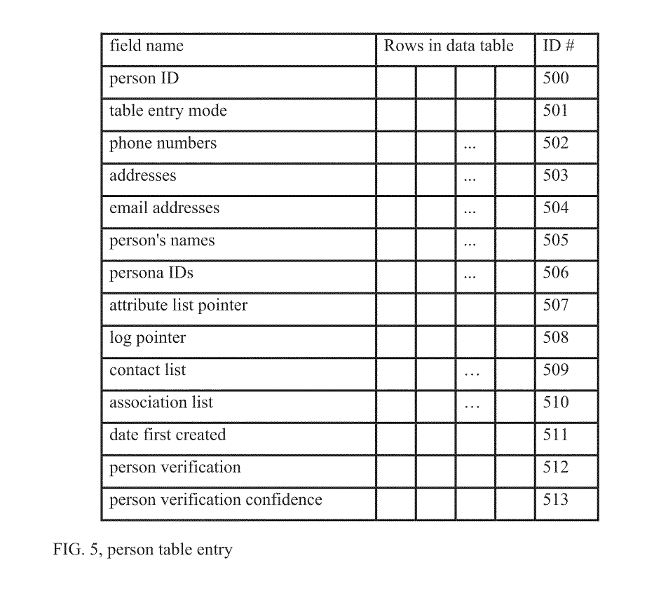

FIG. 5 is a table showing content of a person table entry, according to an example embodiment. A person table entry describes an individual or an aspect (persona) of either a member or the contact of the member. It should be noted that an individual can have more than one person table entry. Some example embodiments detect duplicates, merge the valid ones into a single person table entry and mark the invalid ones as fraudulent. The person table entries are stored in a conventional database and can be accessed by one or more of the fields. The fields in this structure were picked as representative and should not be construed to limit what is taught herein.

Person ID 500 is the unique ID for a person table entry. Table entry mode 501 indicates if this is the root entry for the person, or a persona, and contains one person ID 501 that identifies the person; one or more phone numbers 502 associated with that person; one or more addresses 503, postal or street, associated with that person; one or more person's names 505 that person uses; persona IDs 506, which list the ways this person has elected to be known (note that the person's primary identity as represented by this person table entry is also a persona); attribute list pointer 507, which specifies a list of attribute names which apply to this person; a log pointer 508, which is used to locate log entries; a contact list 509 containing a list of person IDs for all the contacts of the person; an association list 510 which, contains pointers to all of the associations for this person; the date first created 511, which is the date the person table entry was created for this person; a person verification 512 field, which specifies whether the person table entry is “unverified”, “verified”, “potentially verified”, “likely fraudulent”, “fraudulent”; a person verification confidence 513 field that states an estimated probability for the conclusion in the person verification 512 field.

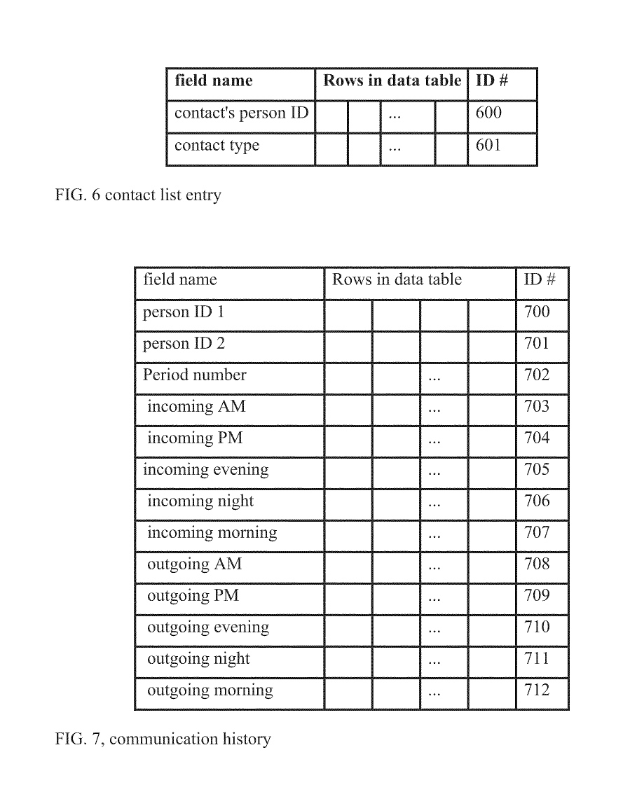

FIG. 6 is a table showing content of a contact list entry, according to an example embodiment. The contact list entry contains a contact's person ID 600, which is the unique identifier of a person in a person table entry (see FIG. 5), which has a person ID 500 that is identical to contact's person ID 600. Contact type 601 indicates whether the corresponding contact is a Direct or Implied contact

FIG. 7 is a table showing communications history data, according to an example embodiment. Communication history data describes the communications between a person defined by a person table entry (see FIG. 5), that person having person ID 500 which is stored in person ID 1 700, and a contact of that person having a different person ID 500, which is stored in person ID 2 701. The rest of the table contains a summary of communications activity for a plurality of periods for incoming and outgoing communications. These communications are described by a set of repeating fields herein described by a generic period, examples of which include: Period number 702 contains sequential integers between 1 and the number (n) of periods being tracked, where n is assigned to the most recent period and one (1) to the least recent period. Incoming AM 703 gives the count of incoming calls to the person from the contact received in the morning hours, incoming PM 704 gives the count of incoming calls to the person from the contact received in the afternoon hours, incoming evening 705 gives the count of incoming calls to the person from the contact received in the evening hours, incoming night 706 gives the count of incoming calls to the person from the contact received in the night hours, incoming morning 707 gives the count of incoming calls to the person from the contact received in the morning hours, outgoing AM 708 gives the count of outgoing calls to the person from the contact sent in the morning hours, outgoing PM 709 gives the count of outgoing calls to the person from the contact sent in the afternoon hours, outgoing evening 710 gives the count of outgoing calls to the person from the contact sent in the evening hours, outgoing night 711 gives the count of outgoing calls to the person from the contact sent in the night hours, and outgoing morning 712 gives the count of outgoing calls to the person from the contact sent in the morning hours,

The intervals may also be specified in hourly increments, such as 10 PM to 6 AM, 6 AM to 8 AM, 8 AM to 10 AM, 10 AM to 12 Noon, etc. In either form the table constitutes a discrete distribution function which can be compared against one another to draw conclusions about one or more individual's relationship to a person.

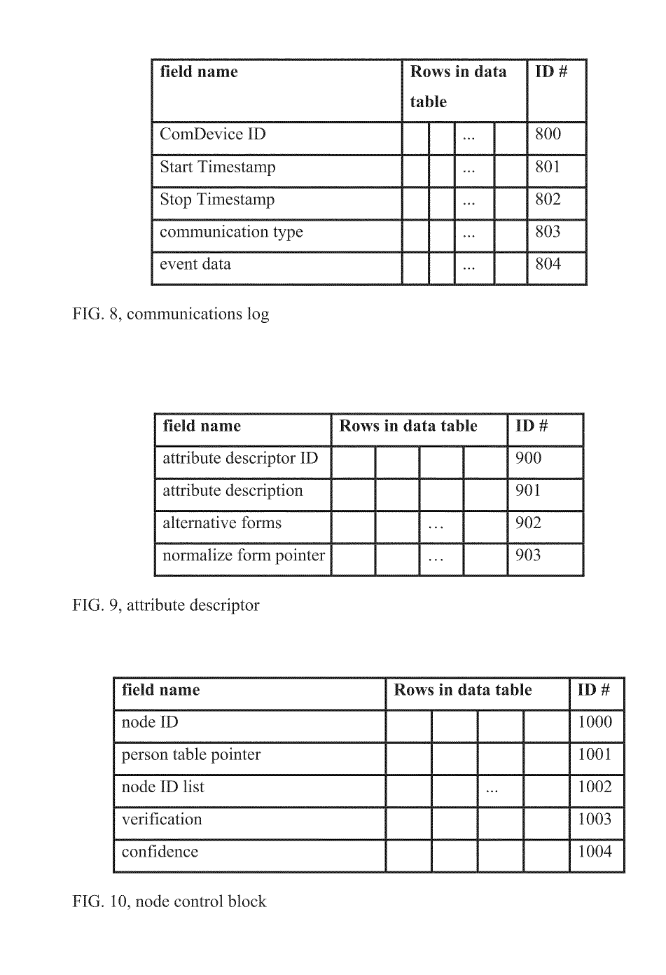

FIG. 8 is a table showing content of a communications log, according to an example embodiment. The communications log describes the phone calls and other communications made and received by a person ID 500 from any of the communications devices for a person 500 in the person table. A communications log describes all the communications made and received by a person ID 500. The fields contained in the communications log may include, for example: ComDevice ID 800 is a unique ID assigned to the phone or internet appliance; Start Timestamp 801 contains the date and time the communication started; Stop Timestamp 802 contains the date and time the communication stopped; communication type 803 indicates the type of call, e.g. call out, call in, call missed, voicemail received, text, email, Facebook posting, etc; and event data 804 contains any text, image, or other digital information associated with the communication. The communications log is used to build communications history data, shown in FIG. 7.

FIG. 9 is a table showing attribute descriptor data, according to an example embodiment. The attribute descriptor data may be composed of an attribute descriptor indicator 900, which is a fix value that identifies the data structure as an attribute descriptor. The attribute descriptor data also includes attribute descriptor ID 900, which is a normalized description of the attributes in the field attribute description 901, and a list of alternative forms 902 of the attribute description. The alternative forms 902 is a list of attribute descriptor IDs 901 that are synonyms for the attribute (e.g., “Pitcher” is an alternative to “Baseball Player” but not vice versa). Normalized form pointer 902 points to the attribute descriptor (see FIG. 9) that has the preferred attribute description. The preferred attribute description is used when adding attributes to the database. For example, when adding the attribute “Baseball Referee” a person's profile, the system would substitute “Baseball Umpire” when a normalized form pointer was found in the “Baseball Referee” attribute descriptor pointing to the “Baseball Umpire” attribute descriptor.

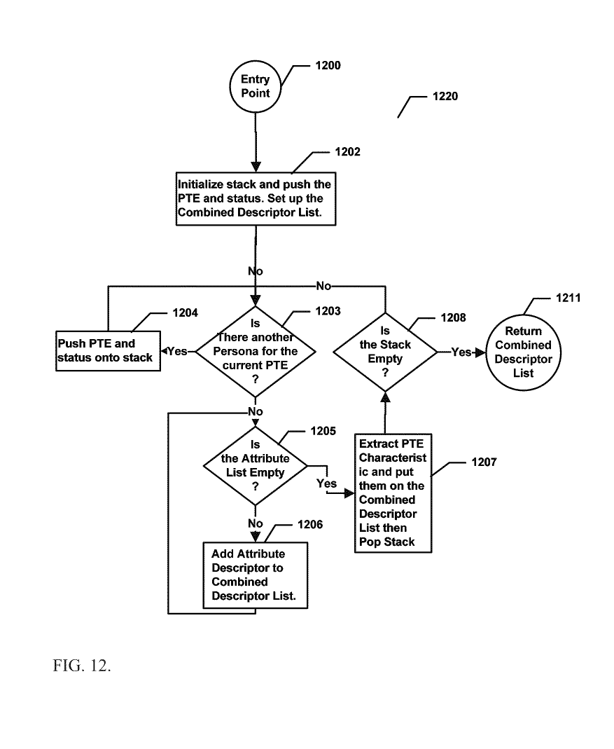

This list is created and updated in the process of adding persons and contacts to the system, and while updating the various persons and contacts information. Attribute descriptors are maintained in a separate table in the database and can be queried by various query languages including SQL. The attribute descriptors are stored in a database table with one entry for each unique attribute. If two people share an attribute, an attribute graph (see FIG. 11) for each individual will have the same leaf for that attribute.

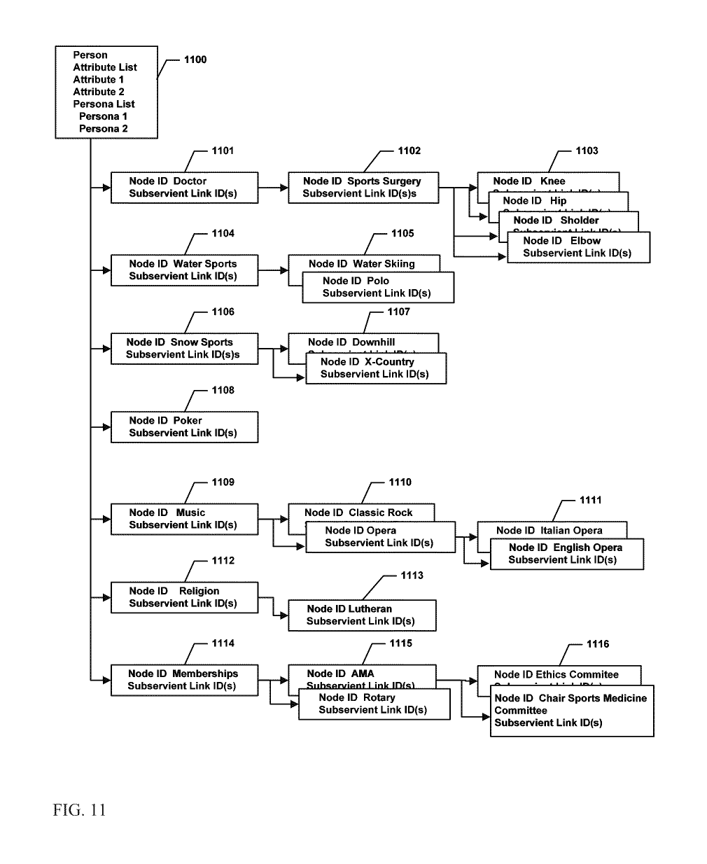

FIG. 10 is a table depicting a node control block data, according to an example embodiment. Node control block data may include a node ID 1000, which in turn includes: a unique ID used to access the node; a person table pointer 1001, which contains the ID necessary to access the related person table entry (see FIG. 5); a node ID list 1002, which lists the node control blocks (see FIG. 3) that are subservient to this node; a verification 1003 field, which specifies whether the node is “unverified”, “verified”, “potentially verified”, “fraudulent”; a confidence 1004 field that states an estimated probability for the conclusion in the verification 1003 field.

FIG. 11 is a diagrammatic representation of a representative attribute graph, according to an example embodiment. The attribute graph describes how the attribute list pointer 507 (block 1100) and the attribute descriptor (see FIG. 9) compose a graph structure that represents the person specified in a person table entry (see FIG. 5). Each person table entry describes an individual who is a member of the system or is a contact of a member. Node 1100 is a person table entry and is the root node of the graph. It contains the attribute list pointer 507 to a list pointing to the next level of the graph containing the primary attributes of the individual or persona. These nodes are described in the node control block (see FIG. 10). The nodes 1101 to 1114 are highest level attributes or personas for the individual. Each of them can be linked to other attributes through additional node control blocks. In the case of node 1108, there were no subservient nodes. Nodes 1102-1113 are second level attributes or personas and are further linked to third level attributes represented by nodes 1103-1116. As many levels as required may be used to represent an individual. This graph is not a separate entity but exists as a result of the IDs and pointers in the various data structures.

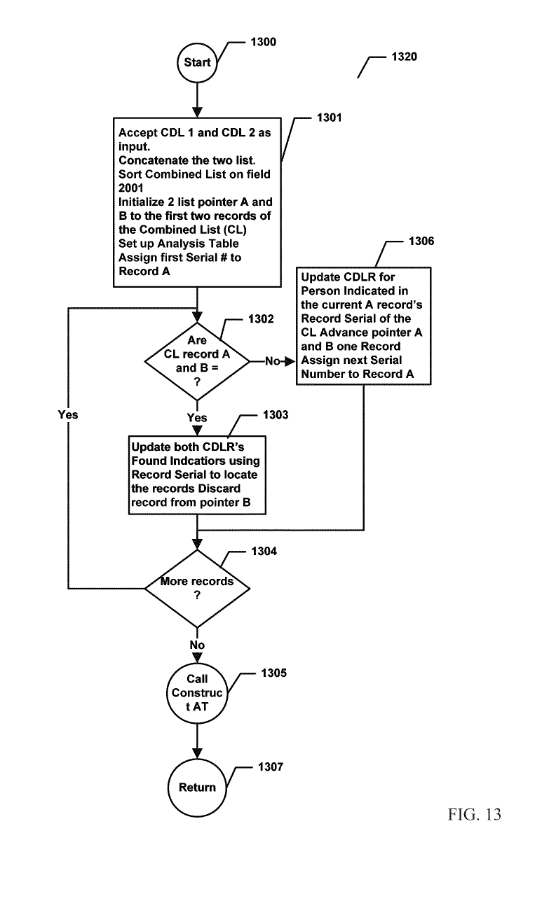

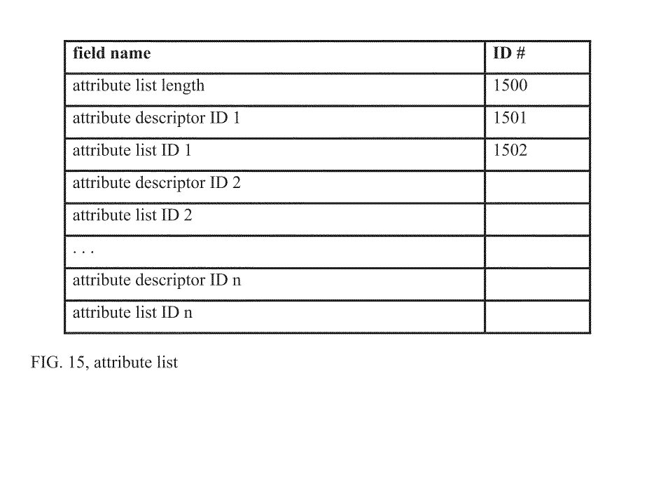

FIG. 12 is a flow diagram showing a combined descriptor list build process 1220, according to an example embodiment. The process 1220 is called with a person table entry for a member as a parameter. The call gives control to operation 1200, which accepts the parameter and passes control to operation 1202, sets up the stack used to queue person table entry(s) for the person and his/her personas(s), pushes the person table entry received in the call along with its status, and sets up the combined descriptor list, control then passes to operation 1203. Operation 1203 examines the status for the person table entry on the top of the stack to determine if there is another persona for that person table entry. If so, control then passes to operation 1204, otherwise to operation 1205, which checks the status of the attribute list (see FIG. 15) associated with the person table entry to determine if the attribute list has been completely processed. If so, control then passes to operation 1207, otherwise operation 1206 ads the next attribute descriptor to the combined descriptor list, control then passes to operation 1205.

Operation 1207 parses the person table entry and puts the various person table entry data elements into the combined descriptor list, then pops the stack, and control passes to operation 1208, which examines the stack to see if it is empty. If not control passes to operation 1203, otherwise the combined descriptor list is returned by operation 1211 to the invoking process.

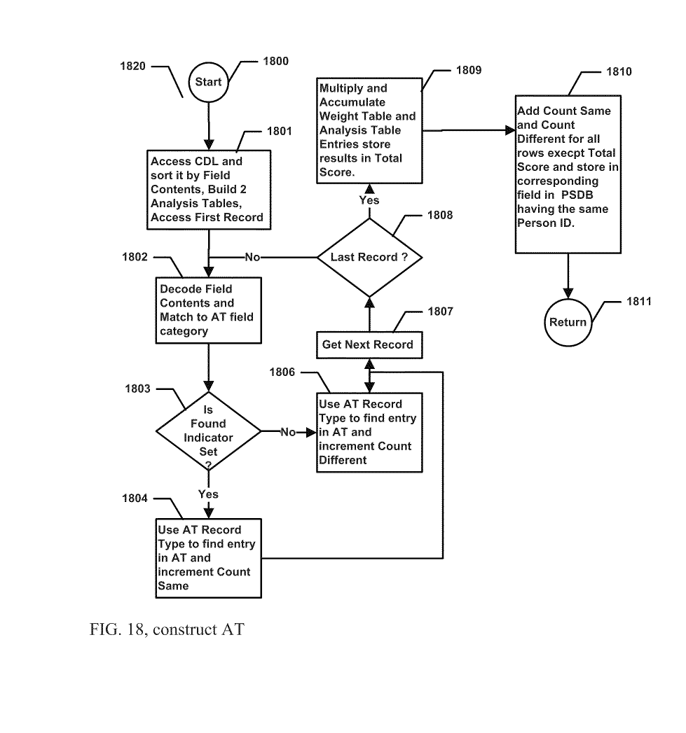

FIG. 13 is a flowchart depicting an evaluation process 1320, according to an example embodiment. The evaluation process 1320 starts with a call to the process (operation 1300) with two combined descriptor lists for person 1 and person 2. Control then passes to operation 1301, which accepts the two parameters and concatenates them into one list called the combined list (CL). Then the CL is sorted with the primary key being person table entry or attribute ID field contents 2001, then two pointers A and B are set up to the first two elements of CL, an analysis table is set up, next the first serial number is store in record serial for the record pointed to by A (henceforth A or record A). Control the passes to operation 1302, which compares the person indicators 2000 and the person table entry or attribute ID field contents 2001 fields for the A and B records to see if both are equal. If so, control then passes to 1303 and the B record is discarded. The secondary effect is the record after the previous B record becomes the B record. If they are not equal control passes to 1306. Operation 1304 sees if there are more records. If so, control then passes to operation 1302, otherwise to operation 1305 which receives a CL with no duplicates. Operation 1306 advances the pointer A and B one record forward in the CL and sets the next serial number into record serial 2002 of record A and control then passes to operation 1304. Operation 1305 calls construct AT (see FIG. 18) and on the return passes control to operation 1307 which terminates the process 1320.

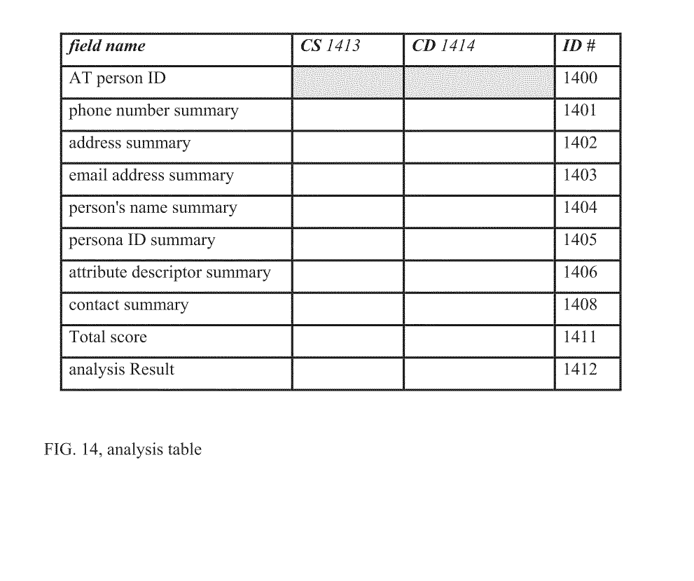

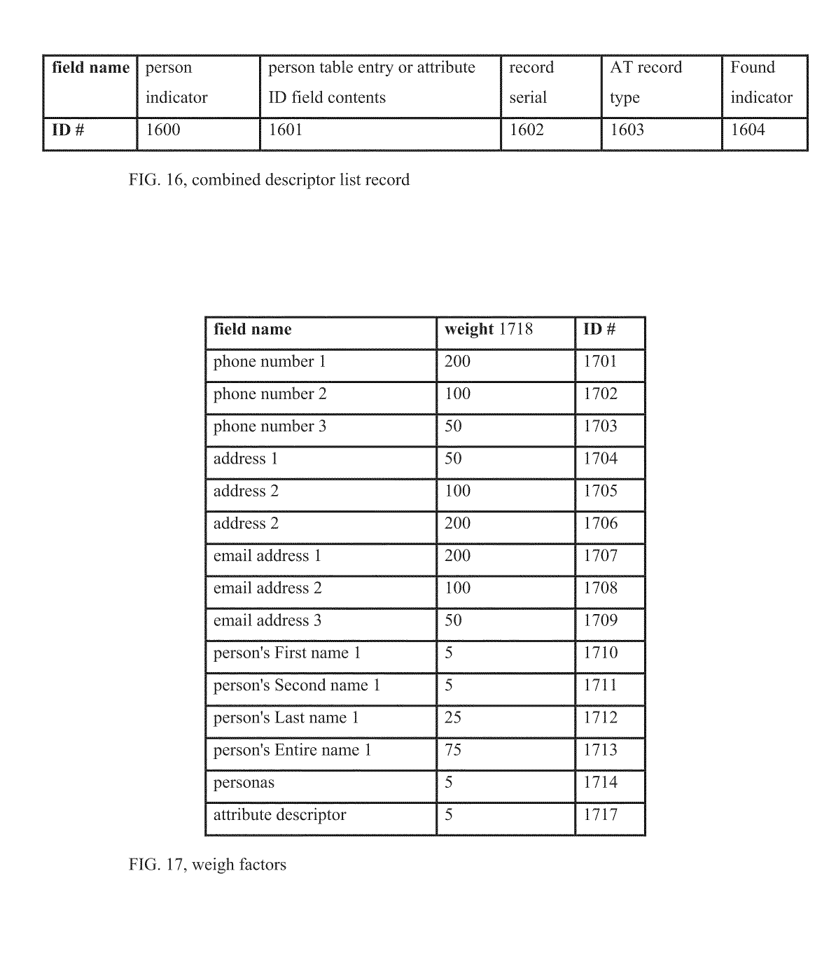

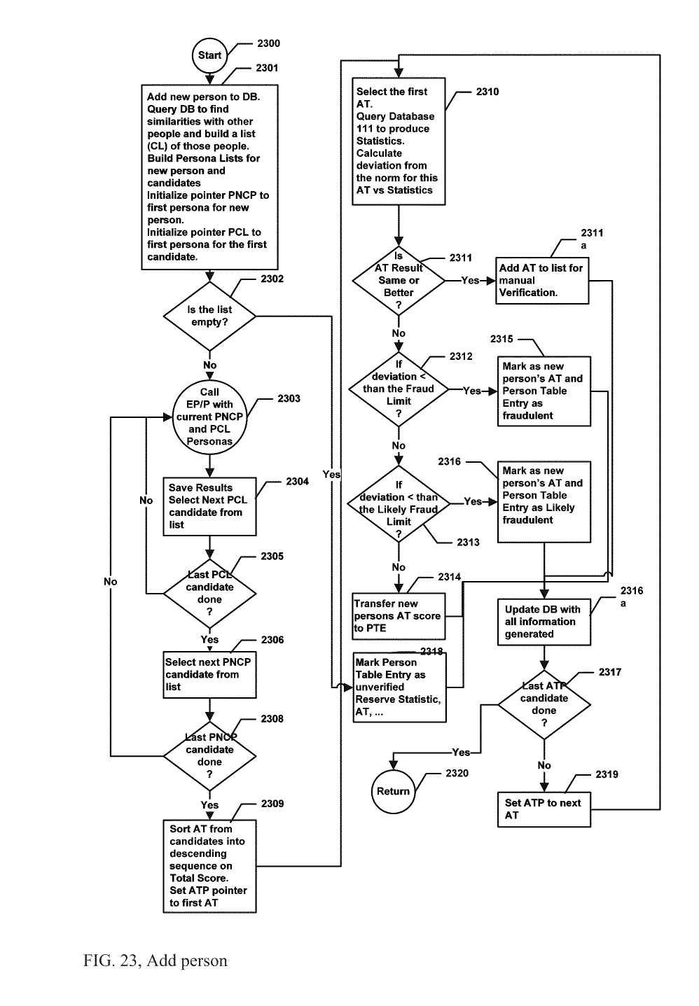

FIG. 14 shows an analysis table, according to an example embodiment. The analysis table is used to record similarities between two people. When two people are compared, two analysis table are used, one for each person. They are called table A and table B herein. There are two fields in each row of the table; CS 1413 is incremented when the item was found in both peoples FIG. 16 combined descriptor list, otherwise the CD 1414 is incremented. The first field in the analysis table is the AT person ID 1400 which identifies the person; this row is grayed out to indicate that the person ID format is overloading the count format. The person ID 600 extracted from the person table entry (see FIG. 5) is used in the data field. The phone number summary 1401, address summary 1402, email address summary 1403, person's name summary 1404, and persona ID summary 1405, attribute descriptor summary 1406, and contact summary 1408 collect the counts for all of the instances of the data type that their field names describe. Total score 1411 is calculated in operation 1809 of FIG. 18 construct AT, and analysis Results 1412 are calculated, as described below with reference to FIG. 23 The analysis table is constructed, in one example embodiment, as described herein with reference to FIG. 18. Once constructed it is used to update the analysis database

FIG. 15 is table showing an attribute list, according to an example embodiment. The attribute list starts with the field attribute list length 1500, which is the number of entries in the list. This field is followed by a number of attribute descriptor IDs 1 1501 and attribute list ID 1 1502 pairs. The attribute descriptor ID specifies the attribute descriptor (see FIG. 9), and the attribute list ID specifies a subservient attribute list of the same format. This structure allows the creation of hierarchies of attributes.

FIG. 16 is a table showing a content and structure of a combined descriptor list record, according to an example embodiment. The combined descriptor list record includes a person indicator 1600, which is the person ID 500 found in a person table entry (See FIG. 5) that was passed to the build combined descriptor list process 1220. person table entry or attribute ID field contents 1601 contains the attribute descriptor ID 1000 or field contents extracted from the person table entry and its various lists person ID 500, table entry mode 500, phone numbers 501, addresses 502, email addresses 504, person's names 505, persona IDs 506, attribute list pointer 507, log pointer 508, contact list 509, association list 510, date first created 511, person verification 512, and person verification confidence 513. Record serial 1602 is a unique number assigned to each record in the combined descriptor list. The AT record type 1603 is an index into the FIG. 14 analysis table where the statistics for this item will be accumulated. Found indicator 1604 is set by the FIG. 13 evaluation process.

FIG. 17 shows a weigh factors table, according to an example embodiment. The weight factors table may include the following fields: phone number 1 1701, phone number 2 1702, phone number 3 1703, address 1, 1704, address 2 1705, address 2 1706, email address 1 1707, email address 2, 1708, email address 3 1709, person's First name 1 1710, person's Second name 1 1711. Person's last name 1 1712, person's entire name 1 1713, personas 1714, attribute descriptor 1717. The weight factors are used in operation 1809 for a construct AT process, described in further detail below with reference to FIG. 18.

FIG. 18 is a flowchart illustrating a construct AT process 1820, according to an example embodiment. The process 1820 starts at operation 1800, which passes control and a pointer to the combined descriptor list (CDL) to operation 1801. The CDL is sorted by person table entry or attribute ID field contents 2001 within person indicator 2000, two empty analysis tables (see FIG<14) are built, whereafter the first record is set as the current record and control passes to operation 1802.

Operation 1802 decodes the AT record type 1603 and, using the person indicator 2000, selects the analysis table (see FIG. 14) for that person and locates the analysis table record. If the record is not present, a record is inserted into the analysis table. Then operation 1803 checks the Found indicator 2004 and if it is set, operation 1804 increments the CS 1413 for that record and control then passes to operation 1807. Otherwise operation 1806 increments the CD 1614 for that record and control then passes to operation 1807, which accesses the next record or finds the end of file. Control then passes to operation 1808, which passes control to operation 1802 if it is not the last record and to operation 1809 if it is the last record.

Operation 1809 performs the same process for both analysis tables, as described in the example Pseudocode below.

```
    Option Explicit
        Dim person as tableStructure
        Dim AT as tableStructure
    Sub operation2009( )
        Dim Individual1, Individual2 as person
        Call CalculateTotalscore(Individual1)
        Call CalculateTotalscore(Individual2)
    End Sub
    Function CalculateTotalscore(Individual as person)
        Dim AT as analysistable
        Dim WT as weight table
        Dim difSum, sameSum as longinteger
        Dim weighttableIdx as long
        difSum = 0
        sameSum =0
        For i = 2 to length(AT) ‘ skip AT person ID 1600
          weighttableIdx = weightLookup(AT.field name(i)) ‘ gets index
          difSum = difSum + AT(I, countDifferent) *
          WT(weighttableIdx)
        sameSum = sameSum + AT(I, countSame) *
_WT(weighttableIdx)
        Next i
        AT.Totalscore(countSame)=sameSum
        AT.Totalscore(countDifferent) = difSum
    End Function
```

Control then passes to operation 1810 that updates a person statistics DB (see FIG. 20) and then operation 1811 terminates the process 1820.

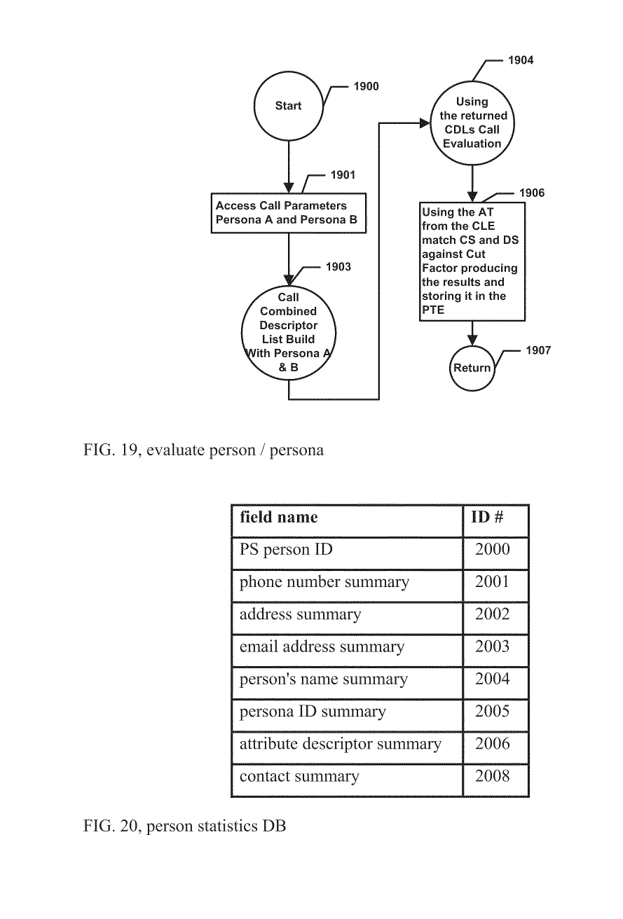

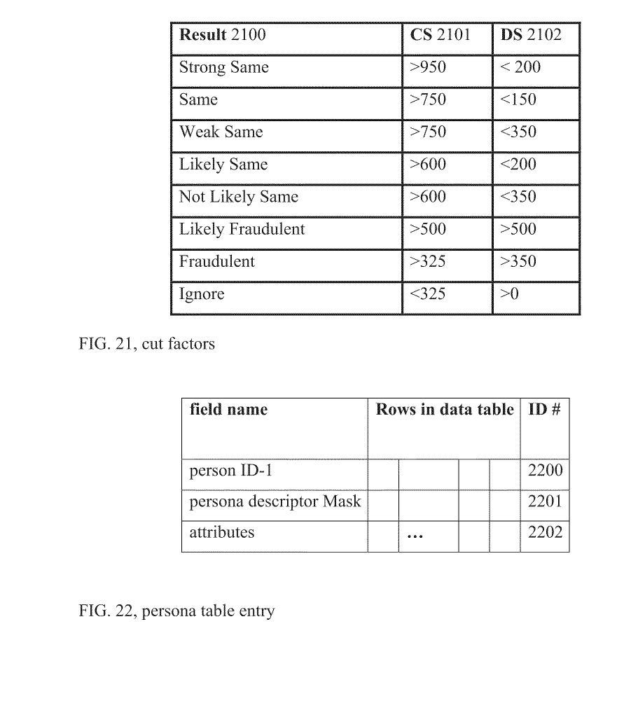

FIG. 19 is a flowchart illustrating an evaluate person/persona and process 1920, according to an example embodiment. Operation 1900 accepts call parameters and passes them to operation 1901, which sets up the control structure for the two personas (e.g., a person may be treated as a persona in example embodiments where their data structures are fundamentally the same) and control passes to operation 1903, which calls combined descriptor list build process (see FIG. 12). When the results are returned, operation 1904 calls the evaluation process (see FIG. 13). When the results are returned, it passes control to operation 1906, which uses fields CS 1413 and CD 1414 from the (FIG. 14) analysis table to look up analysis Result 1412 in the (FIG. 21) cut factors table. This is done, in one example embodiment, as follows:

```
Function Results(CS, CD as Double, cutfactors(3, 8) as String) as String
Dim CF(2, 8) as Double
Dim I as Long
For I = 1 to 8
    If Compare(CS, cutfactors(2,I)) AND Compare(DS, cutfactors(3,I))
    Then
        Results=cutfactors(1,I)
    End if
Next I
End Function
Function Compare(X, tableentry as String) as Boolean
    Dim Operator as string
    Call Extract(tableentry, Operator, tableValue) ‘ gets Operator and
    Value Compare = False
    Select Case Operator
        Case “>”
            If X> tableValue Then Compare = True
        Case “<”
            If X< tableValue Then Compare = True
        Case “<>”
            If X<> tableValue Then Compare = True
        Case “>=”
            If X>= tableValue Then Compare = True
        Case “<=”
            If X<= tableValue Then Compare = True
    End Select
End Function
```

It then stores Results into the person verification 512 field of the (FIG. 5) person table entry and control passes to 1907 which returns to the calling program.

FIG. 20 is a table showing the structure and content of describing person statistics DB, according to an example embodiment. PS person ID 2000 contains the person ID 600 of the person being described in this structure, phone number summary 2001, address summary 2002, email address summary 2003, person's name summary 2004, persona ID summary 2005, attribute descriptor summary 2006, and contact summary 2008 all contain the count of the number of unique instances of the types of fields describe by the data item. There is one entry for each person and persona in the database.

FIG. 21 shows a cut factors table, according to an example embodiment. The cut factors table is a lookup table using the CS 1413 and CD 1414 fields and matching them against the CS 2101 and DS 2102 fields to find the value in the Result 2100 column of the table. The cut factors table is evaluated from top down. The first row matching the inputs provides the value to be used. The Result 2100 column contains a code representing the conclusion to be reached if the inputs match the corresponding criteria column (CS 2101 and DS 2102). This table may be modified based on experience with the system by using data mining techniques to correlate outcomes to cut points.

FIG. 22 is a table illustrating content of a persona table entry, according to an example embodiment. The persona table entry is used to link a person to the associated contacts. It is composed of person ID-1 2200, which identifies the Member described; a persona descriptor Mask 2201, which specifies which fields of the (FIG. 5) person table entry are used for the persona; and attributes 2202 which is analogous to the attribute list pointer 507.

FIG. 23 is a flowchart illustrating an Add person process 2330, according to an example embodiment. The information collected from the client Application 204 or client Application 303, describing the new person is passed to operation 2300, which gives control to operation 2301. Operation 2301 formats the data and inserts the new person into the database 111 by generating a (FIG. 5) person table entry and assigning a person ID 600. Additionally, a persona will be built based on that information. The content of the new structures is then used to query database 111 to find candidate matches to this person. Alternatively, the candidate matches can be selected by following the contact list 509 links to build a subset of database 111, which is then queried in the same manner. The personas for the new member are then built and added to the respective lists. These are assembled into two lists: NCP is the list to the new person's personas and CL is the candidate list, these have pointers PNCPL and a pointer PCL are set to the first member of each list. Control then passes to operation 2302.

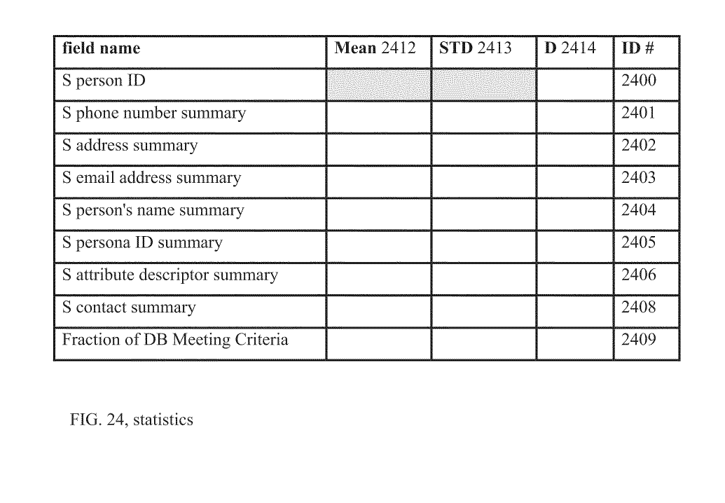

Operation 2302 examines the PNCP if it is null control then passes to operation 2318; otherwise to operation 2303 which calls (FIG. 19) evaluate person/persona and control then passes to operation 2304, which saves the FIG. 16 combined descriptor list records and FIG. 14 attribute tables. Operation 2305 then examines the PCL to see if it is null. If not, control passes to operation 2303; otherwise operation 2306 updates the PNCP list and if empty set the PNCP to null. Operation 2308 checks the PNCP and if not null control then passes to operation 2303. Otherwise operation 2309 sorts the (FIG. 14) attribute tables into descending sequence on Total score 1411 and discards all but the first attribute table. Operation 2310 accesses analysis Results 1412 (CS 1413 and CD 1414) and uses these to query the (FIG. 21) cut factors table and putting the result in analysis Result 1412 (CS 1413). Then the database 111 is queried on the fields corresponding to the description in Rows 2400 through 2408 of the (FIG. 24) statistics, using the corresponding values from the current person table entry, to produce a partially completed statistics table. The query returns the Fraction of DB Meeting Criteria 2409. The process 2330 then calculates a total deviation score as shown in the following example pseudocode.

```
Sub CalculateDevivation(Deviation as Double)
Dim StatsMean(9), StatsSTD(9), TS(9), as Double
    Dim CntSame(9), CntDifferent(9), NumSTD as Double
    Dim PFunction(i) as String
    Dim I as Long
    For I = 1 to 9
        NumSTD = (StatsMean(i)−(CntSame(i)+CntDifferent(i)))/
        StatsStd(i)
        NumSTD = ABS(NumSTD)
        TS(i) = Integrate(PFunction(i), StatsMean(i), _{—}
                StatsStd(i), NumSTD)
    Next I
    Deviation = Max(C₁ * TS(1), C₂ * TS(2)) + C₃ * TS(3) + _{—}
          Max(C₄ * TS(4), C₅ * TS(5)) + C₆ * TS(6) + _{—}
          C₇ * TS(7) + C₈ * TS(8) + C₉ * TS(9)
    ‘ the Max function is used when two variables are deemed to be not
    ‘ statistically independent.
End Sub
Function Integrate(Funct as string, Mean, STD, Limit as double) as double
    ‘ This function uses standard numerical integration software to
    ‘ integrate the function “Funct” from −Limit to + Limit
    Select Case Function
        Case “normal Distribution”
            Integrate = normDist(Mean, STD, Limit)
        Case “Student's t”
            Integrate = Students_t(Mean, STD, Limit)
        Case “Weibul”
            Integrate = Weibul(Mean, STD, Limit)
        Case “Zipf's”
            Integrate = Zipfs(Mean, STD, Limit)
        Case ...
            Integrate = ...(Mean, STD, Limit)
    End Select
End Function
```

Operation 2311 determines whether analysis Result 1412 is “Same” or better control passes to operation 2311a, otherwise control passes to operation 2312. Operation 2311a queues the person (FIG. 5, person table entry) for manual review and passes control to operation 2316a. Operation 2312 checks determined if Deviation less than the Fraud Limit. If so control, passes to operation 2315, otherwise to operation 2313 which checks to see if Deviation is less than the Likely Fraud Limit. If so control passes to operation 2316, otherwise to operation 2314 which takes the value in analysis Result 1412 into person verification 512 and Deviation into person verification confidence 513 and control then passes to operation 2317.

Operation 2315 stores “fraudulent” into person verification 512 and Deviation into person verification confidence 513 and passes control to operation 2316a. Operation 2316 stores “likely fraudulent” into person verification 512 and Deviation into person verification confidence 513 and passes control to operation 2316a. Operation 2317 checks the ATP to see if there are more to process if so control passes to operation 2319, otherwise control passes to operation 2320. Operation 2316 stores Deviation into person verification confidence 513 and passes control to operation 2316a.

Operation 2316a stores the FIG. 14 analysis table, FIG. 20 person statistics DB, FIG. 24 statistics, and FIG. 5 person table entry into the database and passes control to operation 2317. Operation 2319 sets up the next (FIG. 14) analysis table for processing, whereafter control is passed to operation 2310. Operation 2320 terminates the process.

FIG. 24 shows a statistics table, according to an example embodiment. The statistics table is extracted from the database 111 using standard database query languages such as SQL. The column Mean 2412 contains the mean value for the data item described in the corresponding row, the column STD 2413 contains the standard deviation for the data item described in the corresponding row, the column D 2414 specifies the probability distribution to be used for that row. The fields: S person ID 2400, S phone number summary 2401, S address summary 2402, S mail address summary 2403, S person, name summary 2404, S persona ID summary 2405, S attribute descriptor summary 2406, and S contact summary 2408 have the same meaning as the corresponding fields in FIG. 14 analysis table. The Fraction of DB Meeting Criteria 2409 is the number of FIG. 5 person table Entries selected divided by the total number of unique person IDs 600 in the system. Only one person table entry per person ID 600 can be selected.

### Modules, Components and Logic

Certain embodiments described herein as include logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

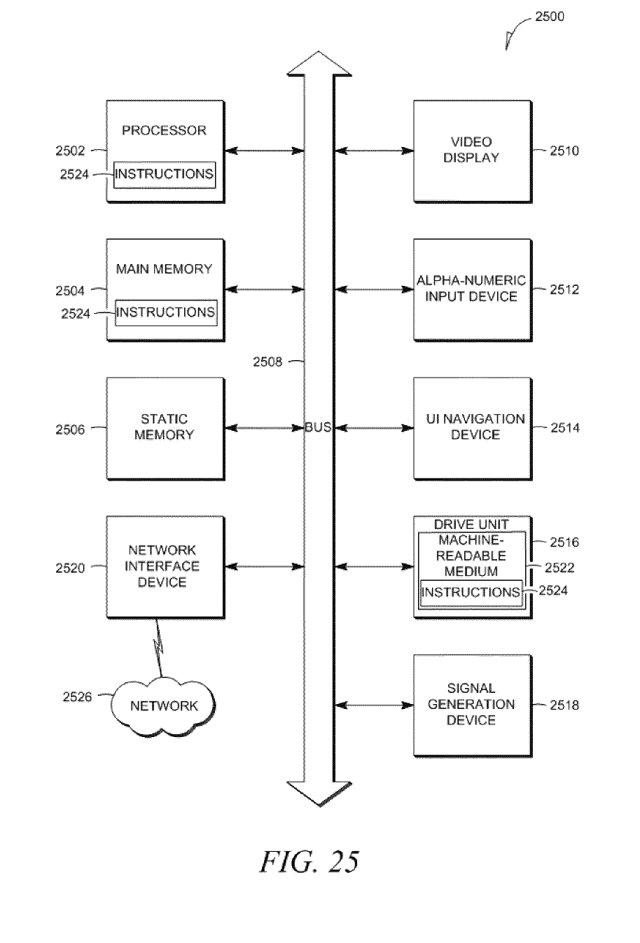

FIG. 25 is a block diagram of machine in the example form of a computer system 2500 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2500 includes a processor 2502 (e.g., a central processing unit (CPU), a graphics processing unit (GPU) or both), a main memory 2504 and a static memory 2506, which communicate with each other via a bus 2508. The computer system 2500 may further include a video display unit 2510 (e.g., a liquid crystal display (LCD) or a cathode ray tube (CRT)). The computer system 2500 also includes an alphanumeric input device 2512 (e.g., a keyboard), a user interface (UI) navigation device 2514 (e.g., a mouse), a disk drive unit 2516, a signal generation device 2518 (e.g., a speaker) and a network interface device 2520.

### Machine-Readable Medium

The disk drive unit 2516 includes a machine-readable medium 2522 on which is stored one or more sets of instructions and data structures (e.g., software) 2524 embodying or utilized by any one or more of the methodologies or functions described herein. The instructions 2524 may also reside, completely or at least partially, within the main memory 2504 and/or within the processor 2502 during execution thereof by the computer system 2500, the main memory 2504 and the processor 2502 also constituting machine-readable media.

While the machine-readable medium 2522 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 2524 may further be transmitted or received over a communications network 2526 using a transmission medium. The instructions 2524 may be transmitted using the network interface device 2520 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
a database containing information concerning uniquely identified individuals, the database further containing a list of attributes describing the individuals; and
a server to compare a list of attributes of a first individual to another list of attributes for a second individual,
wherein the server is to provide one or more metrics indicating a degree of match of the first individual to the second individual based on the comparison.

2. The system of claim 1, wherein the server is to select the second individual based on database queries to locate candidate second individuals, and to select the second individual from the candidate second individuals.

3. The system of claim 2, wherein the server is to select the second individual based on associations between the first individual and the second individual in database entries associated to the first individual.

4. The system of claim 1, wherein the database contains a plurality of identifiers describing the individuals, the server is to include one or more of the identifiers into one or more persona(s), and to combine the identifiers to produce a further comparison of the first individual and the second individual.

5. The system of claim 4, wherein the first individual has a plurality of personas consisting of identifiers that are a subset of the identifiers of the first individual, and that are used as a source of the identifiers used in the comparison.

6. The system of claim 5, wherein the second individual has a plurality of the personas consisting of the identifiers that are a subset of the identifiers of the second individual, and the server is to select the personas of the second individual to make the comparison to t selected persona(s) of the first individual.

7. A system comprising:
a database containing information concerning uniquely identified individuals, the database further containing a list of attributes describing the individuals and a list of identifiers describing the individuals; and
a server to compare the list of attributes and the list of identifiers of a first individual to another list of attributes and list of identifiers for a second individual,
wherein the server is to provide one or more metrics indicating a degree of match of the first individual to the second individual.

8. The system of claim 7, wherein the server is to select the second individual based on linkages between the first individual and the second individual that are documented in database entries associated to the first individual.

9. The system of claim 7, wherein the database includes a plurality of identifiers describing the individuals, and wherein the server is to include one or more of the identifiers into one or more persona(s), and to combine the identifiers to produce a further comparison of the first individual and the second individual.

10. The system of claim 9, wherein the first individual has a plurality of personas consisting of identifiers and attributes that are a subset of the identifiers and attributes of the first individual, and are used as the source of the identifiers and attributes used in the comparison.

11. The system of claim 10, wherein the second individual has a plurality of the personas consisting of the identifiers and attributes that are a subset of the of the identifiers and attributes of the second individual, the server to select the personas of the second individual to make the comparison to the first individual's selected persona(s).

12. A method comprising:
storing information concerning uniquely identified individuals in a database, the database containing a list of attributes describing the individuals;
comparing the list of attributes of a first individual to another list of attributes for an second individual; and
generating one or more metrics indicating a degree of match of the first individual to the second individual, based on the comparison.

13. The method of claim 12, including selecting the second individual based on database queries to find candidate second individuals, and selecting the second individual from the candidate second individuals.

14. The method of claim 13, including selecting the second individual based on associations between the first individual and the second individual that are documented in database entries associated to the first individual.

15. The method of claim 12, wherein the database contains a plurality of identifiers describing the individuals, the method comprising including one or more of the identifiers in one or more persona(s), and combining the identifiers to produce a further comparison of the first individual and the second individual.

16. The method of claim 15, wherein the first individual has a plurality of personas consisting of identifiers and attributes that are a subset of identifiers of the first individual, and that are used as a source of the identifiers used in the comparison.

17. The method of claim 15, wherein the second individual has a plurality of personas consisting of the identifiers and attributes that are a subset of the identifiers and attributes of the second individual, the method comprising selecting the personas of the second individual to make the comparison to selected persona(s) of the first individual.

18. A method comprising:
storing information concerning uniquely identified individuals in a database, the database containing a list of attributes describing the individuals and a list of identifiers describing the individuals;
comparing the list of attributes and the list of identifiers of a first individual to another list of attributes and list of identifiers for an second individual; and
providing one or more metrics indicating a degree of match of the first individual to the second individual based on the comparison.

19. The method of claim 18, including selecting the second individual based on linkages between the first individual and the second individual that are documented in database entries associated to the first individual.

20. The method of claim 18, wherein the database includes a plurality of identifiers describing the individuals, the method comprising including one or more of the identifiers into one or more persona(s), and combining the identifiers to produce a further comparison of the first individual and the second individual.

21. The method of claim 20, wherein the first individual has a plurality of personas consisting of identifiers and attributes that are a subset of the identifiers and attributes of the first individual, and are used as the source of the identifiers and attributes used in the comparison.

22. The method of claim 20, wherein the second individual has a plurality of the personas consisting of the identifiers and attributes that are a subset of the identifiers and attributes of the second individual, the method comprising selecting personas of the second individual to make the comparison to selected persona(s) of the first individual.
